(19) United States
(12) Patent Application Publication
(10) Pub. No.: US 2011/0168124 A1
(43) Pub. Date: Jul. 14, 2011

(54) PISTON FOR AN INTERNAL COMBUSTION ENGINE

(76) Inventor: Martin Nodl, Nurnberg (DE)

(21) Appl. No.: 12/999,719

(22) PCT Filed: Apr. 22, 2009
(86) PCT No.: PCT/EP09/54816

§ 371 Date: Mar. 4, 2011

(30) Foreign Application Priority Data
Jun. 19, 2008 (DE) 102008002536.4

(51) Int. Cl. F02F 3/00

(52) U.S. Cl. 123/193.6

(57) ABSTRACT

The invention relates to a piston for an internal combustion engine, having shaft wall sections on the pressure and counter-pressure side, and connecting walls between the shaft wall sections, characterised in that the connecting walls are arched on the counter-pressure side, and that the connecting walls are largely straight on the pressure side such that the counter-pressure side is more elastic than the pressure side.

### TECHNICAL FIELD

The invention relates to a piston for an internal combustion engine according to the preamble to Claim 1.

In particular with Otto engines there has recently been an increased trend towards direct injection in association with turbocharging. This leads to constantly increasing cylinder pressures and/or the shift of the occurrence of subjection to maximum lateral forces on the piston shaft towards the range of 20 degrees to 30 degrees after the top dead centre. Furthermore, the requirement for the lowest possible piston noises must always be kept in view.

### PRIOR ART

A piston according to the preamble to Claim 1 is known from DE 10 2007 020 447 A1. The piston which is known from DE 198 32 091 A1 has shaft wall sections which are called cladding here, and which are larger on the pressure side than on the counter-pressure side.

### PRESENTATION OF THE INVENTION

The object forming the basis of the invention is to provide a piston for an internal combustion engine which has an improved combination of load capacity, in particular with the most recent trends in the field of engine development, and the piston noises.

This object is achieved with the piston described in Claim 1.

Consequently, the latter has in the first place shaft wall sections on the pressure and counter-pressure side. The shaft wall sections can also be called piston claddings or a piston skirt and essentially constitute sections of the cylinder-shaped surface which corresponds to the inner surface of the cylinder sleeve. However, in those areas where a lateral support is not necessarily required, i.e. in the region of the pin bosses, modern pistons are repositioned so that in the areas required for support on both sides of the piston pin the shaft wall sections described remain. The latter can have a form that changes in the direction of the axis of rotation of the piston. The shaft wall sections described are connected by connecting walls which are essentially produced by repositioning the piston shaft in the region of the pin bosses, and accommodate the pin bosses.

The piston according to the invention is characterised in that the connecting walls are arched on the counter-pressure side, and are largely straight on the pressure side. Due to this the counter-pressure side is more elastic than the pressure side. The form on the counter-pressure side can be called a “figure of 8” form and is comparably elastic due to the arching of the connecting walls. This form has an advantageous effect upon noise development because the piston strikes the counter-pressure side comparably “softly”. This reduces the development of noise and is at the same time acceptable with regard to the loading of components because the latter is less on the counter-pressure side than on the pressure side.

A comparably high degree of rigidity is achieved on the pressure side due to the largely straight connecting walls by means of which the shaft wall section is supported on the pressure side. This form can be called a “slipper design”, and is advantageously suitable for absorbing the strong lateral forces occurring as a result of the trends described within the framework of engine development.

Furthermore, for a harmonic and durable form of the counter-pressure side the arching of the connecting walls on the counter-pressure side is predominantly in the same direction as the arching of the shaft wall section on the counter-pressure side. In other words, the arched form of the shaft wall section on the counter-pressure side crosses over to harmonically inwardly arched connecting walls at the point at which the shaft wall section is released from the “notional” total cylinder shape and the connecting walls begin. In other words, both the shaft wall section and the connecting walls on the counter-pressure side are concavely arched, as viewed from the inside of the piston. In the region of the cross-over of the connecting walls into the pin bosses an at least slight convex arching can follow, as viewed from the inside of the piston.

By means of the invention the opposing requirements for the absorption of strong lateral forces on the one hand and reduced noise development on the other hand are advantageously combined by the different sides of the piston being designed differently and according to the respective requirements. In particular, it has been highlighted by the initial trials that in this way the piston also fulfils the more stringent requirements as a result of increasing cylinder pressures and/or the described shift of the occurrence of subjection to maximum lateral forces.

Advantageous further developments of the piston according to the invention are described in the further claims.

In order to establish the desired elasticity on the counter-pressure side it is currently preferred to form the shaft wall section on the counter-pressure side with greater width, at least in some areas, than the shaft wall section on the pressure side.

The described rigid form on the pressure side and the more elastic form on the counter-pressure side can be supported by the wall thickness of the shaft wall section and/or of the connecting walls on the counter-pressure side being reduced, at least in some areas, in relation to the rest of the shaft wall section and/or the other connecting walls, and/or by the wall thickness of the shaft wall section and/or of the connecting walls being increased, at least in some areas, on the pressure side in relation to the rest of the shaft wall section and/or the other connecting walls. In this way one can achieve a further increase in elasticity on the counter-pressure side and/or an increase in rigidity on the pressure side, and this advantageously supports the effect striven for by the invention.

### BRIEF DESCRIPTION OF THE DRAWING

In the following an exemplary embodiment illustrated in the drawing is described in greater detail.

The FIGURE shows a cross-section through the piston according to the invention in the region of the pin bosses.

### DETAILED DESCRIPTION OF A PREFERRED EMBODIMENT OF THE INVENTION

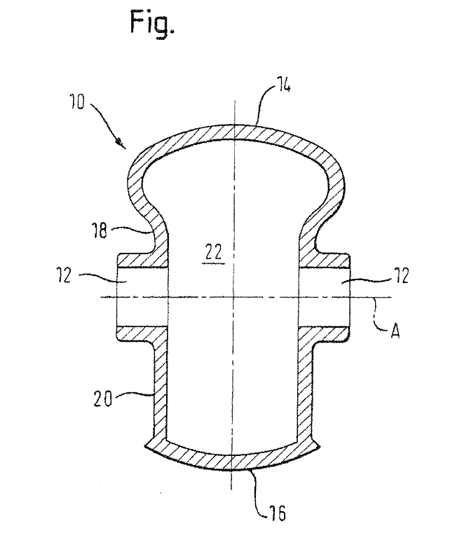

In FIG. 1 a cross-section, i.e. a section perpendicular to the axis of rotation of the piston 10 according to the invention is shown. The pin bosses 12 and the shaft wall sections 14 and 16 with which the piston is supported in the cylinder sleeve can be seen. In the FIGURE 14 identifies the shaft wall section on the counter-pressure side, and 16 the shaft wall section on the pressure side. As a comparison of the two sides by means of the FIGURE shows, the shaft wall section 16 on the pressure side is somewhat narrower, i.e. as measured substantially in the direction of the piston pin axis A, than the shaft wall section 14 on the counter-pressure side. Moreover, the connecting walls 18 and 20 of the two sides differ. On the pressure side the connecting walls 20 are largely straight in order to support the shaft wall section 16 on the pressure side as rigidly as possible so that the loads can be absorbed. On the other hand, the connecting walls 18 on the counter-pressure side are arched so that a more elastic form is provided here which is advantageous for the piston noises. With the exemplary embodiment shown, the connecting walls 18 on the counter-pressure side are convexly arched from the pin bosses 12 initially over a short section, as viewed from the inside 22 of the piston, and then pass harmonically into a concave arching followed by the concave arching of the shaft wall section 14 on the counter-pressure side.

With the exemplary embodiment shown all of the connecting walls 18 are formed such that they accommodate the pin bosses 12 on the inside of the latter, i.e. on the side directed towards the piston interior 22. Furthermore, with the exemplary embodiment shown the shaft wall section 16 extends a little beyond the connecting walls 20 on the outside on the pressure side in order to make available a sufficient area in order to support the piston 10.

1. A piston for an internal combustion engine, having shaft wall sections on pressure and counter-pressure sides of the piston, and connection walls between the shaft wall sections, the connecting walls being arched on the counter-pressure side, and the connecting walls being largely straight on the pressure side, wherein the arching of the connecting walls on the counter-pressure side is substantially in the same direction as the arching of the shaft wall section on the counter-pressure side such that the counter-pressure side is more elastic than the pressure side.

2. The piston according to claim 1, wherein wherein the shaft wall section on the counter-pressure side is wider, at least in some areas, than the shaft wall section on the pressure side.

3. The piston according to claim 1, wherein the wall thickness of the shaft wall section and/or of the connecting walls is reduced, at least in some areas, on the counter-pressure side in comparison with the rest of the shaft wall section and/or the other connecting walls, and/or the wall thickness of the shaft wall section and/or of the connecting walls is increased, at least in some areas, on the pressure side in comparison with the rest of the shaft wall section and/or the other connecting walls.
